(19) United States
(12) Patent Application Publication
(10) Pub. No.: US 2020/0184401 A1
(43) Pub. Date: Jun. 11, 2020

(54) RAW MATERIAL EVALUATION PROCESS

(71) Applicant: ExxonMobil Research and Engineering Company, Annandale, NJ (US)

(72) Inventors: Dimitri J. Papageorgiou, Stewartsville, NJ (US); Francisco Trespalacios, Spring, TX (US); Shivakumar Kameswaran, Katy, TX (US); Myun-Seok Cheon, Whitehouse Station, NJ (US); Timothy A. Barckholtz, Whitehouse Station, NJ (US)

(21) Appl. No.: 16/705,899

(22) Filed: Dec. 6, 2019

Related U.S. Application Data
(60) Provisional application No. 62/776,615, filed on Dec. 7, 2018.

(51) Int. Cl. G06Q 10/06; G06Q 30/02; G06Q 10/04; G06Q 10/08

(52) U.S. Cl. CPC G06Q 10/06375; G06Q 30/0201; G06Q 30/0204; G06Q 10/087; G06Q 30/0283; G06Q 10/04; G06Q 30/0206

(57) ABSTRACT

Aspects of the technology described herein comprise a raw material valuation system that is able to quantify an outcome of various raw material management decisions. Raw material management decisions can include, but are not limited to, purchasing a raw material, selling a raw material, transferring a raw material within a chemical production system, and substituting a proposed purchase of a first raw material with the purchase of a second material. The raw material valuation system can quantify a contemplated changes to a raw material management plan by comparing an optimal reference usage plan to an optimal updated usage plan. The raw material valuation system can calculate a breakeven sale price for a raw material in inventory or a breakeven purchase price for a raw material to be purchased. The raw material valuation system used to generate the reference usage plan and the updated usage plan can use a multi-period optimization model.

### CROSS REFERENCE TO RELATED APPLICATION

This application relates and claims priority to U.S. Provisional Patent Application No. 62/776,615, entitled “Raw Material Evaluation Process” filed on Dec. 7, 2018, the disclosure of which is incorporated herein by reference in its entirety.

### FIELD

Modeling outcomes of alternative supply schedules for a manufacturing process. The manufacturing process modeled can refine oil into gasoline and/or other products.

### BACKGROUND

Chemical manufacturers optimize raw material purchase decisions and raw material processing decisions through computer modeling. A raw material purchase decision can involve both the type of raw material to purchase and a price at which to purchase the raw material. The raw material processing decisions can optimize use of raw materials within a production process to produce the desired mixture of end products. The modeling can take into account both the chemical production context and financial context.

Simulation of a chemical production process involves using specialized software to define physical characteristics of interconnected equipment and processes that form the chemical production process. Chemical production modeling requires a knowledge of the properties of the chemicals input and generated within different portions of the process, as well as the physical properties and characteristics of the components of the system, such as tanks, pumps, pipes, reactors, distillation columns, heat exchanges, pressure vessels, and so on. Knowledge of the physical properties allow the model to simulate flow rates, pressure drop, heat loss, and the chemical reactions that will occur under the given conditions.

### SUMMARY

Aspects of the technology described herein comprise a raw material valuation system that is able to quantify an outcome of various raw material management decisions. Raw material management decisions can include, but are not limited to, purchasing a raw material, selling a raw material, transferring a raw material within a production system, and substituting a proposed purchase of a first raw material with the purchase of a second material. The raw material valuation system can quantify contemplated changes to a raw material management plan by comparing an optimal reference usage plan to an optimal updated usage plan. An optimal production plan is a plan calculated to provide the maximum profit for a given set of raw material inputs. The reference plan is based on existing raw materials. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but that is not yet purchased, is not included in the existing raw materials. The updated usage plan is based on a change to the existing raw materials. The change can be an addition or subtraction.

The raw material valuation system generates an optimal updated production plan using an alternative set of inputs that add to or subtract from existing raw materials. For example, a sale of existing raw material inventory is a subtraction from the existing raw materials. An addition to the existing raw materials is a purchase of a quantity of a specific quantity of raw material.

The raw material valuation system can calculate a breakeven sale price for a raw material in inventory. The raw material valuation system can also calculate a breakeven purchase price for a raw material to be added into a production plan when the proposed raw material purchase differs from a current optimal plan.

The model used to generate the reference usage plan and the updated usage plan can be a multi-period optimization model. The multi-period optimization model can simultaneously select a volume of raw materials to be purchased along with the delivery date for those materials. As mentioned, the multi-period optimization model may use both existing inventory and additional raw material purchases to arrive at an optimal plan. The multi-period optimization model contrasts with a volume then scheduling model. A volume then scheduling model selects an optimized volume of different raw materials to purchase over the course of a planning period, such as a month. The arrival of the volume is then scheduled to make sure that the required volume is on hand when needed.

### BRIEF DESCRIPTION OF THE DRAWINGS

FIG. 1 is a diagram showing an exemplary chemical production process that could be modeled, according to an aspect of the technology described herein;

FIG. 2 is a diagram showing a raw material valuation modeling system for a chemical production process, according to an aspect of the technology described herein;

FIGS. 3-5 are flow charts for methods of modeling raw material valuation, according to an aspect of the technology described herein; and

FIG. 6 is a diagram showing a computing system environment suitable for use with aspects of the technology described herein.

### DETAILED DESCRIPTION

### Overview

Aspects of the technology described herein comprise a raw material valuation system that is able to quantify an outcome of various raw material management decisions. Raw material management decisions can include, but are not limited to, purchasing a raw material, selling a raw material, transferring a raw material within a production system, and substituting a proposed purchase of a first raw material with the purchase of a second material. The raw material valuation system can quantify contemplated changes to a raw material management plan by comparing an optimal reference usage plan to an optimal updated usage plan. An optimal production plan is a plan calculated to provide the maximum profit for a given set of raw material inputs. The reference plan is based on existing raw materials. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but that has not yet been purchased, is not included in the existing raw materials. The updated usage plan is based on a change to the existing raw materials. The change can be an addition or subtraction.

The raw material valuation system generates an optimal updated production plan using an alternative set of inputs that add to or subtract from existing raw materials. For example, a sale of existing raw material inventory is a subtraction from the existing raw materials. An addition to the existing raw materials is a purchase of a quantity of a specific raw material.

The optimal plan (either reference or updated) may include a plan to purchase different available raw materials at different times during the planning period. In other words, the raw material usage plan in an optimal plan can include both existing raw materials (inventory+purchased) and raw materials that have not yet been purchased. The optimal plan can be used to schedule additional raw material purchases. Once an agreement is reached to purchase a raw material, the purchased raw material is considered an existing raw material for future plans.

An unexpected disruption to plant production, such as caused by a natural disaster, mechanical failure, supply disruption, or some other reason may make the sale of raw material inventory the best way to maximize overall operating profits. The raw material valuation system can calculate a breakeven sale price for a raw material in inventory. The first step can be to generate an optimal reference usage plan that contemplates the disruption. For example, if a plant will be shut down for a week, then the optimal reference plan would calculate the maximum profit that can be made given the disruption. Once the optimal reference usage plan is calculated, an estimated reference profit expected from the plan is determined.

Next, an optimal updated usage plan that does not include a designated amount of raw material to be sold as existing inventory is calculated. As before, an estimated updated profit for the optimal updated usage plan is calculated. The breakeven sale price for the designated amount can be the difference in profit between the optimal reference plan and the updated usage plan, plus any costs associated with the sale. The price per unit sale price, such as per barrel, can be calculated by dividing the breakeven sale price for the total amount by the units in the designated amount.

The raw material valuation system can also calculate a breakeven purchase price for a raw material to be added into a production plan when the proposed raw material purchase differs from purchases in a current optimal plan. For example, a tanker of oil may come on the market for immediate purchase when a production facility run by a different entity has an unexpected disruption. The breakeven purchase price is the price at which the oil in the tanker may be purchased while maintaining the same profit as provided by the current reference case.

As described previously, the first step can be to calculate an optimal reference usage plan and corresponding reference profit. The optimal reference usage plan is based on existing raw material inventory, as described. The next step can be to calculate an optimal updated usage plan by adding the raw material to be purchased to existing inventory with a corresponding price of zero. The profit for the optimal updated usage plan can be calculated. The breakeven purchase price for the proposed purchase can be the reference profit minus the updated profit.

The model used to generate the reference usage plan and the updated usage plan can be a multi-period optimization model. The multi-period optimization model can simultaneously select a volume of raw materials to be purchased along with the delivery date for those materials. As mentioned, the multi-period optimization model may use both existing inventory and additional raw material purchases to arrive at an optimal plan. The multi-period optimization model contrasts with a volume then scheduling model. A volume then scheduling model selects an optimized volume of different raw materials to purchase over the course of a planning period, such as a month. The arrival of the volume is then scheduled to make sure that the required volume is on hand when needed. The multi-period optimization model optimizes both the volume and delivery at the same time.

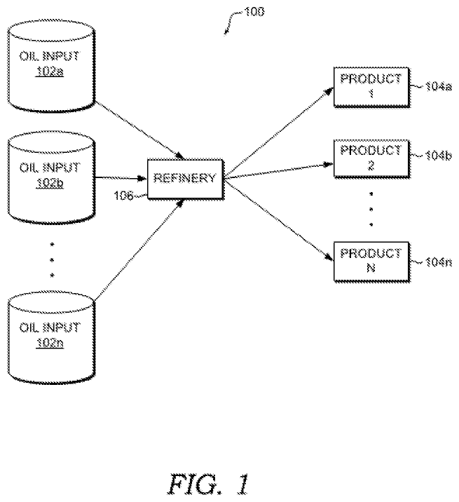

Turning now to FIG. 1, a high level process diagram of an oil refining processes is shown. Use of the raw material valuation model described herein is not limited to oil refining, but the description will largely be in context of oil refining to help the reader understand the model. The valuation process described herein is applicable to various manufacturing operations including various chemical production processes.

This discussion generally relates to tools and methods for analyzing an optimized solution (or solutions) generated from models of hydrocarbon processing systems. The models can be related to individual processes or multiple (optionally related) processes. In some aspects, multiple processes can correspond to processes within a single hydrocarbon processing facility, or the processes can correspond to multiple facilities, including but not limited to models for optimizing an objective across multiple facilities. In this discussion, reference may be made to hydrocarbon processing. Unless specifically noted otherwise, it is understood that hydrocarbon processing generally includes processes typically involved in extraction, conversion, and/or other refining of petroleum, and processes typically involved production, separation, purification, and/or other processing of chemicals based on hydrocarbon or hydrocarbon-like feeds. Examples of processes related to refining of hydrocarbons include any processes involved in production lubricants, fuels, asphalts, and/or other products that can generally be produced as part of a petroleum processing work flow. Examples of processes related to chemicals production include any processes related to production of specialty chemicals, polymers (including production of feeds for polymer production), synthetic lubricants, and/or other products that can generally be produced as part of a hydrocarbon-based chemicals production workflow.

In this discussion, hydrocarbon processing is defined to include processing of and/or production of streams containing hydrocarbons and hydrocarbonaceous or hydrocarbon-like compounds. For example, many mineral petroleum feeds and bio-derived hydrocarbon feeds contain substantial quantities of compounds that include heteroatoms different from carbon and hydrogen. Such heteroatoms can include sulfur, nitrogen, oxygen, metals, and/or any other type of heteroatom that may be found in a mineral petroleum feed and/or bio-derived hydrocarbon feed. As another example, some chemical production processes involve reagents corresponding to alcohols and/or other organic compounds that contain heteroatoms other than carbon and hydrogen. Still other chemicals production processes may involve production of products that are not hydrocarbons, such as reforming processes that convert hydrocarbon or hydrocarbon-like compounds to generate hydrogen, water, and carbon oxides as products. Yet other processes may form hydrocarbon or hydrocarbon-like compounds from reagents such as hydrogen, water, and carbon oxides. It is understood by those of skill in the art that all of the above types of processes are intended to be included within the definition of hydrocarbon processing in this discussion.

FIG. 1 shows a hydrocarbon refining system 100. The refining system 100 represents a real world system of equipment that processes real oil to produce real products. The raw material valuation system 200 estimates the performance of the refining system 100. The refining system 100 includes takes oil volumes 102a, 102b, and 102n as input. The 102n volume indicates that the many more than three different types of oil volumes can be used. Each oil volume can be a different type of oil, though some of the oil volumes input to the refinery may be the same type. For example, the purchase of two tankers of Arab Light Crude could result in two volumes of similar oil.

Each oil volume may represent a bulk purchase of oil having roughly similar characteristics. Bulk purchase can include, a tanker of oil or a purchase from a pipeline. Each oil volume can have unique molecular and chemical characteristics measured by an assay. No two crude oil types are identical and there are crucial differences in crude oil quality. The results of crude oil assay testing provide extensive detailed hydrocarbon analysis data for refiners. Assay data helps refineries determine if a crude oil feedstock is compatible for a particular petroleum refinery or if the crude oil could cause yield, quality, production, environmental and/or other problems.

The oil volume's molecular characteristics measured in an assay can include the % by weight of different molecules such as, methane, ethane, propane, isobutene, n-butane, isopentane, n-pentane, cyclopentane, C6 paraffins, C6 naphthenes, benzene, C7 paraffins, C7 naphthenes, and toluene. Measured properties can include, but are not limited to, Density @ 15° C. (g/cc), API Gravity, Total Sulphur (% wt), Pour Point (° C.), Viscosity @ 20° C. (cSt), Viscosity @ 40° C. (cSt), Nickel (ppm), Vanadium (ppm), Total Nitrogen (ppm), Total Acid Number (mgKOH/g), Mercaptan Sulphur (ppm), Hydrogen Sulphide (ppm), and Reid Vapour Pressure (psi). The price per volume can also be considered as an oil volume characteristic. Each oil volume can be measured in barrels or some other suitable unit.

The refinery 106 can be a single refinery or a collection of refineries. The oil volumes are input to the refinery 106, which processes the oil to produce products 104a, 104b, and 104n. The products 104a, 104b, and 104n can include petroleum naphtha, gasoline, diesel fuel, asphalt base, heating oil, kerosene, liquefied petroleum gas, jet fuel and fuel oils. Different refinery set ups and different oil inputs can produce different combinations of products. Roughly 1 barrel of input should allow the refinery to produce roughly 1 barrel of combined products.

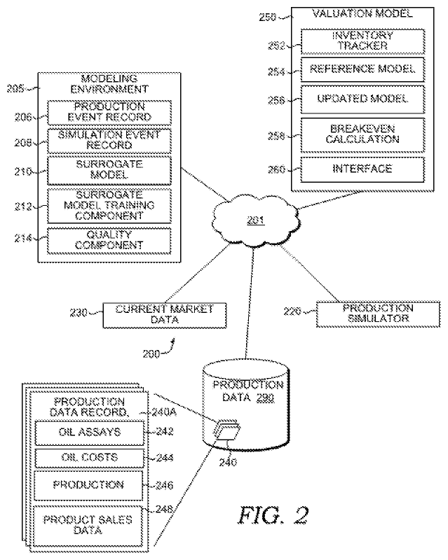

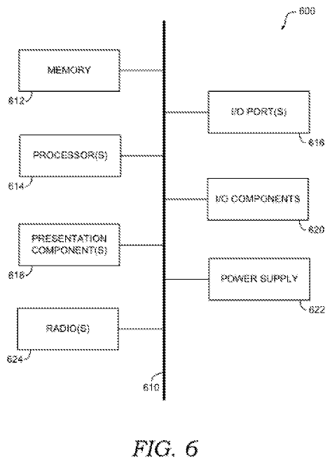

Turning now to FIG. 2, a block diagram is provided illustrating an exemplary raw material valuation system 200 in which some embodiments of the present disclosure may be employed. The components of raw material valuation system 200 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of raw material valuation system 200 are associated with one or more applications, services, or routines. In particular, such applications, services, or routines may operate on one or more user devices (e.g., personal computers, tablets, desktops, laptops) and servers, may be distributed across one or more user devices and servers, or be implemented in the cloud. Moreover, in some embodiments, these components of raw material valuation system 200 may be distributed across a network 201, including one or more servers and client devices, in the cloud, or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the disclosure described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regard to specific components shown in example raw material valuation system 200, it is contemplated that in some embodiments functionality of these components can be shared or distributed across other components.

As noted above, it should be understood that the raw material valuation system 200 shown in FIG. 2 is an example of one system in which embodiments of the present disclosure may be employed. Each component shown may include one or more computing devices. The raw material valuation system 200 should not be interpreted as having any dependency or requirement related to any single module/component or combination of modules/components illustrated therein. Each may comprise a single device or multiple devices cooperating in a distributed environment. For instance, the raw material valuation system 200 may comprise multiple devices arranged in a distributed environment that collectively provide the functionality described herein. Additionally, other components not shown may also be included within the network environment. It should be understood that the raw material valuation system 200 and/or its various components may be located anywhere in accordance with various embodiments of the present disclosure.

The raw material valuation system 200 generally operates to calculate a breakeven value for a raw material associated with a chemical production process. As briefly mentioned above, each component of the raw material valuation system 200, including modeling environment 205, production simulator 220, valuation model 250, production data component 290, production data event records 240, and their respective subcomponents, may reside on a computing device (or devices). For example, the components of the raw material valuation system 200 may reside on the exemplary computing device 600 described below and shown in FIG. 6, or similar devices. Accordingly, each component of the raw material valuation system 200 may be implemented using one or more of a memory, a processor or processors, presentation components, input/output (I/O) ports and/or components, radio(s), and a power supply (e.g., as represented by reference numerals 612-624, respectively, in FIG. 6).

The valuation model 250 calculates a breakeven sale price or breakeven purchase price for a raw material that can be used in a chemical production process. The breakeven price is based on the difference between the optimal modeled result of the process using current inventory and the optimal modeled result when the current inventory is augmented by a proposed purchase or sale. The valuation model 250 can use the output of surrogate model 210 to calculate an optimal modeled result. Data from the current market data component 230 can be combined with the model data to generate an estimated profit for each model. The difference between the estimated reference profit and updated profit can be the breakeven value of the material being evaluated.

The valuation model 250 includes an inventory tracker 252, reference model generator 254, updated model generator 256, breakeven calculator 258, and interface 260. The inventory tracks the existing inventory of raw materials available for use in a chemical production process. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but that has not yet been purchased, is not included in the existing raw materials.

In addition to the existing raw material quantities, the inventory tracker can include financial information for various raw materials and final products produced by the chemical production process. The current and projected sale prices/purchase prices of various raw materials and finished goods can be accessed from current market data component 230. In one aspect, the current market data component 230 accesses a distributed ledger (i.e., blockchain) data store.

The reference model generator 254 generates an optimal reference production plan for the chemical production process using a first raw material scenario. The optimal reference production plan is calculated using a computer model, such as surrogate model 210 or production simulator 220, of the chemical production process. The optimal reference plan is the production plan that will produce the most profit given the first raw material scenario. The optimal reference production plan uses the first raw material scenario as input, but can also make optimized purchases of additional raw materials with optimized delivery dates. The optimal reference production plan can also include a schedule for inputting the various raw materials, either existing materials or additional materials, into the process. The output of the optimal reference production plan can provide an estimated amount of finished products to be produced and sold. As described above, a surrogate model can be used to model the production quickly and efficiently. The computer model can be a multi-period optimization model. An estimated reference profit is calculated for the chemical production process that will result from implementing the optimal reference production plan. The estimated profit is calculated using the amount of each finished product to be produced and an estimated sale price for the finished products minus the costs to produce the finished products. The estimated profit may be calculated using the products produced by the plan. Alternatively, the profit may be calculated without specifying the products produced. In other words, the estimated profit can be the output produced by the model.

The multi-period optimization model can simultaneously select a volume of raw materials to be purchased along with the delivery date for those materials. As mentioned, the multi-period optimization model may use both existing inventory and additional raw material purchases to arrive at an optimal plan. The multi-period optimization model contrasts with a volume then scheduling model. A volume then scheduling model selects an optimized volume of different raw materials to purchase over the course of a planning period, such as a month. The arrival of the volume is then scheduled to make sure that the required volume is on hand when needed. The multi-period optimization model optimizes both the volume and delivery at the same time.

The updated model generator 256 generates an optimal updated production plan for the chemical production process using a second set of inputs. The second set of inputs differs from the first set of inputs through the inclusion or subtraction of a raw material. A breakeven purchase price for the added material can be calculated when the second set of inputs include an additional raw material. An amount of raw material in the existing materials used to calculate the reference plan is absent from second set of inputs if a breakeven sale price is to be calculated. As with the reference plan, the optimal updated production plan is calculated using a computer model of the chemical production process, such as the surrogate model 210 or the production simulator 220. The optimal updated production plan is selected to optimize profits given the new inputs. An estimated updated profit is calculated for the chemical production process that should result from implementing the optimal updated production plan. The estimated updated profit may be calculated using the products produced by the plan. Alternatively, the profit may be calculated without specifying the products produced. In other words, the estimated profit can be the output produced by the model.

The breakeven calculator 258 calculated either a breakeven purchase price or breakeven sale price for a contemplated transaction. As described, a reference profit and an updated reference product were calculated. The breakeven sale price for the designated amount of raw material can be the difference in profit between the optimal reference plan and the updated usage plan, plus any costs associated with the sale. The price per unit sale price, such as per barrel, can be calculated by dividing the breakeven sale price for the total amount by the units in the designated amount.

The raw material valuation system can also calculate a breakeven purchase price for a raw material to be added into a production plan when the proposed raw material purchase differs from purchases in a current optimal plan. For example, a tanker of oil may come on the market for immediate purchase when a production facility run by a different entity has an unexpected disruption. The breakeven purchase price is the price at which the oil in the tanker may be purchased while maintaining the same profit as provided by the current reference case.

The next step can be to calculate an optimal updated usage plan by adding the raw material to be purchased to existing inventory with a corresponding price of zero. The profit for the optimal updated usage plan can be calculated using zero as the price for the new raw material. The breakeven purchase price for the proposed purchase can be the reference profit minus the updated profit.

The output interface 260 communicates the breakeven price to a requesting user. The output interface can also communicate other information, such as differences in materials purchased during the production process. For example, the reference plan may purchase quantity A of raw material of type A from source A, whereas the updated plan purchases quantity B of raw material type B from source B. These differences between plans may be communicated via the output interface 260.

The production simulator 220 can produce plans for the reference model generator 254 and/or the updated model generator 256. The production simulator 220 calculates probable outputs of one or more chemical reactions at specified physical conditions within a production environment. Combining a series of these calculations allows the simulation to show a probable output, given an input. A simulation is constrained by physical conditions in the plant. The production simulator 220 can run thousands of different simulations with different inputs and/or operating conditions. The inputs can be a combination of different oil types. Each oil type can be defined by an oil assay. Each simulation can produce a unique output expressed as a volume of different products produced. The simulations can be used as input to train the surrogate model 210. The simulations can be stored by the simulation event record component 208.

The production data component 290 stores production data for the refinery system. Production data can be any information about the inputs, production, and production outputs of the refinery. In one aspect, the production data forms a series of production data event records 240, such as production data record 240A. The production data record 240A can represent production data for a period of time such as a day, week, month, or some other unit of time. The production data record can include oil assays 242 for the oil input to the refinery system during the time memorialized in the production data record 240A. As mentioned, a refinery may work on a combination of different oil inputs at a given time. The production data record 240A can include the characteristics of each oil input, such as oil input volumes described previously with reference to FIG. 1, and the volume of each type of oil introduced to the refinery.

Financial data 244 for the oil input to the refinery can be recorded in the production data record 240A. The financial data 244 can include the actual amount paid for each type of oil input to the refinery during the timeframe associated with production data record 240A. In addition to the actual purchase costs, the financial data 244 can include relevant transportation costs, storage costs, and other financial data that helps provide an accurate measure of cost associated with the oil input to the refinery.

The production data 246 describes the type of products made by the refinery during the timeframe associated with the production data record. Each type and volume of product produced can be described. The product sales data 248 describes the sales price obtained for each product produced. The production sales data can include transportation and storage costs. The production sales data can include a storage time for each product produced. The storage time is a duration of time the product spent in storage between production and sale. This is just one example of production data record 240A. The production data component 290 can include any information that describes the refinery inputs, outputs, production setups, and financial data related to any aspect of production. When multiple refineries are modeled, each production record can specify a particular refinery associated with the production data.

The modeling environment 205 can produce models for the reference model generator 254 and/or the updated model generator 256. The modeling environment 205 includes a production event record component 206, simulation event record component 208, a surrogate model 210, a surrogate model training component 212, and a quality component 214. The modeling environment 205 generates an estimated optimal output of a refinery for a given input. Various machine learning models may be used to implement the surrogate model. Implementations using a regression surrogate, neural network, and convex hull models are described below. At a high level, the optimization problem solved for by a simulation can be:

xₒₚₜ=arg maxₓf(x, c)

s. t. g(x, c)≤0

The function can be solved to maximize different variables. In the case of raw material valuation, the objective function f is the profit; the decision variable x may include, for example, crude quantities and feedstock quantities. The conditions c can include crude price, product price, compositional data, and unit capacity.

The surrogate model 210 can be trained using production event records or simulation event records. Accordingly, an initial step is to gather the training data. The production event record component 206 gathers production data and forms production event records that can be used to train the surrogate model 210. The production event record can follow a schema for production data that allows production data to be input as training data. Each production event record can represent a real-life input to the refinery and a real-life output from the refinery.

The input and output can be represented as multi-dimensional vectors. For example, a single vector could represent a single oil input to a refinery at a particular point in time associated with an event record. The dimensions in the input vector could represent oil assay variables, cost variables, and other features of the oil input, such as the volume of a particular input. The production output can also be represented as a vector with variables representing characteristics and volumes of the various products produced. The production event records can include inferences. For example, the inputs in a record can be matched to time-shifted outputs. As an example, if it takes one day for a refinery to process a barrel of oil, then the output from a day could be matched with inputs from a previous day.

The simulation event record component 208 builds simulation event records. The simulation event records can follow the same schema as the production event records. Like the production event records, the simulation event records can be represented as multi-dimensional vectors. The simulation event records can include data from a computer simulation of a production process, such as those generated by production simulator 220. The simulations can be performed for the express purpose of generating training data, but can also include data from simulations run during optimization exercises or for any other purpose in the course of running simulations. It is desirable to collect simulation event records that cover a large number of possible model conditions. Both x and c in the objective function can be high-dimensional inputs, such as vectors with 100 or more dimensions. As an example, x in the case of a refinery can be a vector that specifies amounts of different constituents in and characteristics (e.g., viscosity, density) of the crude oil mixture being fed to the refinery for processing.

Simulation event records used to train the model can be produced with constraints that mimic conditions in which the refinery is actually operated. Events generated from simulations that are not near conditions actually used in the real world may have less value. Aspects of the technology can focus event generation in a neighborhood of a typical refinery operating point of the input variables x and the conditions c. The goal is to generate a plurality of event records that contain a large fraction of feasible solutions.

The surrogate model training component 212 trains the surrogate mode using the simulation and production of event records. Different types of models can be used and the training can vary according to the model.

### The Linear Regression Based Surrogate

The linear regression based surrogate works by substituting the objective function and constraints by data-based (piece-wise) linearized approximations. The resulting optimization problem is a linear program or a mixed integer linear program, which can be solved relatively efficiently with optimization software. A linear regression model assumes a linear relationship between the input variables and the output. In a simple regression model, the form of the model could be y=B0+B1*x, where B0 and B1 are coefficients. Training the regression model means learning the values of the coefficients used in the representation.

In one aspect, the overall objective function can be split into multiple functions. For example, the objective function can be split into two contributions:

f(x, c)=f*(x, c₁)+L(x, c₂)

where L is linear in x₂; c₁ and c₂ are subvectors of c, i.e. c=(c₁ c₂). For example, in the case of raw material valuation, the crude cost is linear in the crude quantities (cost=price*quantity) and is therefore an example of a linear function L. The benefit of this step is that it reduces the difficulty of the surrogate modeling task while maintaining high model quality. Also, this linear component typically has an interpretable meaning, e.g., the crude cost in the example given.

Different methods exist for calculating the coefficients. These methods include simple linear regression, ordinary least squares, gradient descent, and regularization methods. Regularization methods seek to both minimize the sum of the squared error of the model of the training data using ordinary least squares and also to reduce the complexity of the model. Regularization training methods include the lasso regression and the ridge regression. The lasso regression modifies the ordinary least square training method to minimize the absolute sum of the coefficients (B0+B1). The ridge regression modifies the least square regression method to minimize the squared absolute sum of the coefficients. Once the coefficients are calculated, solving the model comprises solving the equation for a specific set of inputs x.

### Neural Network Based Surrogate

In one aspect, the surrogate model is a neural network. As used herein, a neural network comprises at least three operational layers. The three layers can include an input layer, a hidden layer, and an output layer. Each layer comprises neurons. The input layer neurons pass data to neurons in the hidden layer. Neurons in the hidden layer pass data to neurons in the output layer. The output layer then produces a result, such as estimated profit, estimated production cash flow, estimated production volumes, etc. Different types of layers and networks connect neurons in different ways. For example, some layers may be fully connected where every output from a neuron in a first layer is fed to every neuron in a subsequent layer. In other cases, outputs from a neuron in a first layer are only fed to less than all of the neurons in a subsequent layer.

Neurons have weights, an activation function that defines the output of the neuron given an input (including the weights), and an output. The weights are the adjustable parameters that cause a network to produce a correct output. The weights are adjusted during training. Once trained, the weight associated with a given neuron can remain fixed. The other data passing between neurons can change in response to a given input (e.g., group of oil assays). Retraining the network with an additional training data can update one or more weights in one or more neurons.

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network).

The neural network is trained by feeding production event records and simulation event records to the model. In one aspect, the input layer to the neural network can include a single neuron for each feature describing the oil inputs to the process. Additional neurons can operate on cost data. The output from the production or simulation record is then provided by the surrogate model training component 212. The weights are adjusted so that the given input comes closer to producing the desired output. This process is repeated with numerous training records. Once trained, the neural network will estimate refinery output for a given oil input.

The quality component 214 tests the accuracy of the trained model. In one aspect, a subset of available simulation event records or production event records are set aside for testing. The simulation event records and production event records provide an accurate output for a given input. In order to test the trained model, the input from a production or simulation event record can be provided to the model. The output calculated by the model can then be compared to the output associated with the input in the event record. This process can be repeated to generate an estimated model error. Depending on the error, the model could be retrained. In one aspect, models can underperform with certain types of inputs, especially if they do not match inputs found in the training data. In this case, additional training data near the inputs that produced a large or undesirable error rate can be intentionally generated, for example, by running simulations, and used to retrain the model.

### Convex Hull Based Surrogate

In another aspect, the surrogate model uses a convex hull calculation to model the solution space. As described previously, the training data includes both input and output sets. The input sets can be characteristics of different crude oils being fed to the refinery. The outputs can be the products produced. Financial data can be included for both the inputs and outputs. The training data can be used to build a convex hull, which is a representation of the solution space. If X is the set of all decision variables in the training data, then the convex hull is the minimal convex set that contains all points in X. The convex hull will include all points in the training data and additional points that are not in the training data output sets. Once calculated, the convex hull can be used to predict a solution for an input that is not in the training data. Constraints may be used to keep the input within ranges that are consistent with the space modeled by the convex hull.

As mentioned, the input to the surrogate model can be multi-dimensional. For example, the input can be defined as a combination of different crude oil characteristics. If ten different crude oils are being fed into the refinery and each crude is described by ten different characteristics, then the input space for the convex hull model has 100 dimensions. In some aspects, it may be advantageous to reduce the model complexity by characterizing types of crudes in the input. In the above example, if each oil in the input is represented by a single characterization, then this could reduce the input dimensions from 100 to 10. The crude oil inputs could be grouped by characteristics used in the market to describe the origin on the oil, such as West Texas crude (WTI), Brent Blend, or OPEC crude. Other grouping by similar physical characteristics of different crudes may be used. The characteristics of different batches (e.g., tankers) of oil from these sources can vary, but characteristics of different batches can be similar enough to find an optimized solution with the surrogate model.

Another approach to reducing the input dimensions can be to preprocess the input data to generate an estimate of composite characteristics of a crude oil blend to be modeled. For example, if 10 different crudes are mixed into a refinery for processing, then a composite density, composite sulfur content, composite cost/barrel, etc. can be calculated. The characteristics found to have the strongest correlation to a modeled output can be selected to define the input space. For example, only the six most strongly correlated characteristics may be input to the model.

In one aspect, the output space can be multi-dimensional. For example, the output space could be represented by different volumes of jet fuel, kerosene, gasoline, etc. Alternatively, the output could be represented as percentage of different products produced per barrel of oil input (e.g., 5% jet fuel, 30% gasoline).

In another aspect, the output space can be reduced to a single dimension by using financial data as a proxy for a more complex representation of the output. For example, the output could be expressed as revenue/barrel of input or profit/barrel of input.

If an approach is used to reduce the dimensions of the input or output space, then the same approach should be used on the training data and the input set used to generate the convex hull model.

Selecting the training data can be an important part of the model building process. The training data can be selected using knowledge of the chemical production process. In one aspect, only simulation event records falling within a range from a normal operating range found in real-world operations are selected for training. Simulations may be run for various reasons including to test operating conditions that are not likely to be found in the real world. For example, some simulations may demonstrate the benefit of not running the process in certain ranges. Simulations that demonstrate a poor performance may be described as negative simulations. They may illustrate ranges at which the process should not be operated.

The negative simulations may be excluded from a training set. The actual training set may be limited to event records having simulation inputs within a range from actually observed inputs in the real-world production process. The range may be set using knowledge of the chemical production process and can vary from limitation to limitation. In one aspect, the range is ⅛ of a standard deviation from the average input found in an operating scenario.

A chemical production process may have different operating scenarios. For example, a first scenario may use a first type of oil as a primary input with four other types mixed in. In this case, the percentage of each type of oil may be an input and the percentage of each may fluctuate within a range designed to produce the optimal output. In a second scenario, none of the first type of oil may be input to the process. Instead, a second primary oil type is input to the process along with the four other types. The percentage of the four other types may be very different than in the first scenario in order to achieve an optimal result. In fact, the percentage ranges for different types of oil may not overlap in between scenarios. For example, in the first scenario, a third oil type may be between 15-20% of the input. In the second scenario, the third oil type may be between 5-10% of the input. Knowledge of the process can be used to identify different scenarios and reasonable ranges of inputs in each scenario. These ranges can then be used to select the training data.

Various algorithms may be used for calculating a convex hull of a solution set. Chan's algorithm can be used for two and three-dimensional cases. The Quickhull algorithm may be used in multi-dimensional cases. Use of other algorithms is possible, particularly if the output space is planar. In some instances, the vertices by themselves can be used to represent a convex hull in its “V-representation” without any algorithm.

Constraints can be placed on the input space to limit inputs to a feasible range. Alternatively, a notification can be issued if the input parameters to the model differ from the training data by more than a notification threshold.

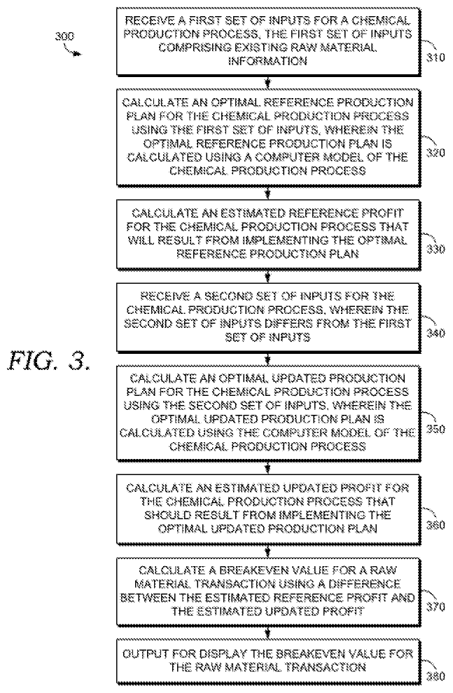

Turning now to FIG. 3, a method 300 for modeling raw material valuation is provided, according to an aspect of the technology described herein. Method 300 may be performed, at least in part, by executing computer code running on one or more computing devices.

At step 310, a first set of inputs for a chemical production process are received. The first set of inputs comprise existing raw material information. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but that has not yet been purchased, is not included in the existing raw materials.

In addition to the existing raw material information, the first set of inputs can include financial information for various raw materials and final products produced by the chemical production process. The first set of inputs can also include availability information for different raw materials. In the context of an oil refinery, oil with different characteristics, such as density, can be considered a different raw material.

At step 320, an optimal reference production plan is calculated for the chemical production process using the first set of inputs. The optimal reference production plan is calculated using a computer model of the chemical production process. The optimal reference production plan can include additional raw materials to be purchased and a delivery date for those materials. The optimal reference production plan can also include a schedule for inputting the various raw materials, either existing materials or additional materials, into the process. The output of the optimal reference production plan can provide an estimated amount of different finished products to be produced. As described above, a surrogate model can be used to model the production quickly and efficiently. The computer model can be a multi-period optimization model, as described previously.

At step 330, an estimated reference profit is calculated for the chemical production process that will result from implementing the optimal reference production plan. The estimated revenue is calculated using the amount of each finished product to be produced and an estimated sale price for the finished products. The profit is calculated by subtracting costs of the raw materials and other manufacturing costs from the revenue.

At step 340, a second set of inputs for the chemical production process is received. The second set of inputs differs from the first set of inputs. The second set of inputs can include an additional raw material if a breakeven purchase price is to be calculated. An amount of raw material in the existing materials can be absent from second set of inputs if a breakeven sale price is to be calculated.

At step 350, an optimal updated production plan is calculated for the chemical production process using the second set of inputs. The optimal updated production plan is calculated using a computer model of the chemical production process. The optimal updated production plan is selected to optimize profits given the new inputs.

At step 360, an estimated updated profit is calculated for the chemical production process that should result from implementing the optimal updated production plan.

At step 370, a breakeven value for a raw material transaction is calculated using a difference between the estimated reference profit and the estimated updated profit. Other factors, such as a cost resulting from the transaction, can be included in the breakeven calculation.

At step 380, the breakeven value for the raw material transaction is output for display.

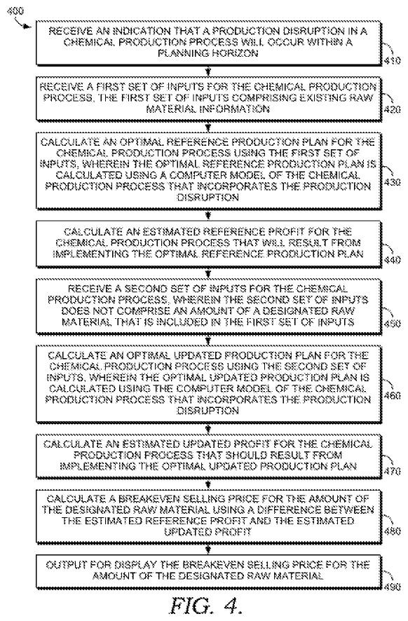

Turning now to FIG. 4, a method 400 for modeling raw material valuation is provided, according to an aspect of the technology described herein. Method 400 may be performed, at least in part, by executing computer code running on one or more computing devices.

At step 410, an indication is received that communicates details about a production disruption in a chemical production process that will occur within a planning horizon. The indication can include a duration of the disruption. When the disruption is partial, rather than a complete shutdown, the indication can provide a detailed explanation of impacts on capacity to produce one or more products or process different raw materials. The indication is used to update the model.

At step 420, a first set of inputs for the chemical production process is received. The first set of inputs comprise existing raw material information. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but has not yet been purchased, is not included in the existing raw materials.

In addition to the existing raw material information, the first set of inputs can include financial information for various raw materials and final products produced by the chemical production process. The first set of inputs can also include availability information for different raw materials. In the context of an oil refinery, oil with different characteristics, such as density, can be considered a different raw material.

At step 430, an optimal reference production plan is calculated for the chemical production process using the first set of inputs. The optimal reference production plan is calculated using a computer model of the chemical production process that incorporates the production disruption. The optimal reference production plan can include additional raw materials to be purchased and a delivery date for those materials. The optimal reference production plan can also include a schedule for inputting the various raw materials, either existing materials or additional, into the process. The optimal reference production plan can provide an estimated amount of different finished products to be produced. The computer model can be a multi-period optimization model, as describe previously.

At step 440, an estimated reference profit is calculated for the chemical production process that will result from implementing the optimal reference production plan. The estimated revenue is calculated using the amount of each finished product to be produced and an estimated sale price for each of the finished products. The profit is calculated by subtracting costs from the revenue.

At step 450, a second set of inputs for the chemical production process is received. Method 400 can calculate a breakeven selling price for an existing raw material. The second set of inputs does not comprise an amount of a designated raw material that is included in the first set of inputs. In other words, the second set of inputs can include all of the first set of inputs, except that the designated raw material to be sold is excluded.

At step 460, an optimal updated production plan for the chemical production process is calculated using the second set of inputs. The optimal updated production plan is calculated using the computer model of the chemical production process that incorporates the production disruption.

At step 470, an estimated updated profit is calculated for the chemical production process that should result from implementing the optimal updated production plan.

At step 480, a breakeven selling price for the amount of the designated raw material is calculated using a difference between the estimated reference profit and the estimated updated profit. Other factors, such as a cost of the transaction (e.g., transportation cost, commissions), can be included in the breakeven calculation. The revenue from selling the designated raw material can be included in the estimated updated profit calculation.

At step 490, the breakeven selling price for the amount of the designated raw material is output for display.

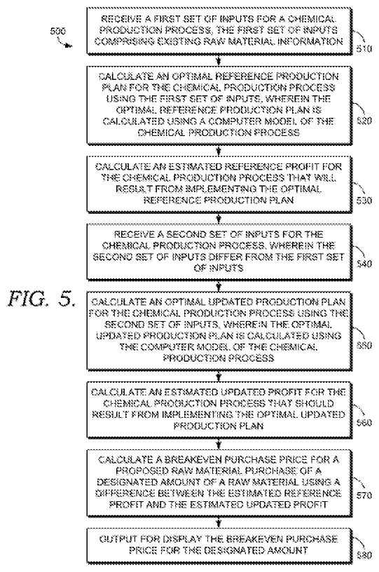

Turning now to FIG. 5, a method 500 for modeling raw material valuation is provided, according to an aspect of the technology described herein. Method 500 may be performed, at least in part, by executing computer code running on one or more computing devices.

At step 510, a first set of inputs for a chemical production process is received. The first set of inputs comprise existing raw material information. The existing raw materials include existing inventory at the time of modeling and purchased raw materials that have not yet arrived as an input. For example, a tanker of oil that is scheduled to arrive in four weeks is included in the existing raw materials. A tanker of oil that is available for purchase, but has not yet been purchased, is not included in the existing raw materials.

In addition to the existing raw material information, the first set of inputs can include financial information for various raw materials and final products produced by the chemical production process. The first set of inputs can also include availability information for different raw materials. In the context of an oil refinery, oil with different characteristics, such as density, can be considered a different raw material.

At step 520, an optimal reference production plan is calculated for the chemical production process using the first set of inputs. The optimal reference production plan is calculated using a computer model of the chemical production process. The optimal reference production plan can include additional raw materials to be purchased and a delivery date for those materials. The optimal reference production plan can also include a schedule for inputting the various raw materials, either existing materials or additional, into the process. The optimal reference production plan can provide an estimated amount of different finished products to be produced during the planning horizon. The computer model can be a multi-period optimization model, as describe previously.

At step 530, an estimated reference profit is calculated for the chemical production process that will result from implementing the optimal reference production plan.

At step 540, a second set of inputs for the chemical production process is received. Method 500 can include calculation of a breakeven purchase price for a raw material. The second set of inputs differ from the first set of inputs. In particular, the second set of inputs can include a raw material to be purchased with an associated cost of $0.

At step 550, an optimal updated production plan is calculated for the chemical production process using the second set of inputs. The optimal updated production plan is calculated using the computer model of the chemical production process.

At step 560, an estimated updated profit is calculated for the chemical production process that should result from implementing the optimal updated production plan.

At step 570, a breakeven purchase price is calculated for a proposed raw material purchase of a designated amount of a raw material using a difference between the estimated reference profit and the estimated updated profit. Other factors, such as a cost resulting from the transaction, can be included in the breakeven calculation.

At step 580, the breakeven purchase price for the designated amount is output for display.

### Exemplary Operating Environment

Referring to the drawings in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof Exemplary memory includes solid-state memory, hard drives, optical-disc drives, etc. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, vibrating component, etc. I/O ports 618 allow computing device 600 to be logically coupled to other devices, including I/O components 620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

A computing device may include a radio 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### Embodiments

Embodiment 1. A method for modeling raw material valuation, comprising: receiving a first set of inputs for a chemical production process, the first set of inputs comprising existing raw material information; calculating an optimal reference production plan for the chemical production process using the first set of inputs, wherein the optimal reference production plan is calculated using a computer model of the chemical production process; calculating an estimated reference profit for the chemical production process that will result from implementing the optimal reference production plan; receiving a second set of inputs for the chemical production process, wherein the second set of inputs differs from the first set of inputs; calculating an optimal updated production plan for the chemical production process using the second set of inputs, wherein the optimal updated production plan is calculated using the computer model of the chemical production process; calculating an estimated updated profit for the chemical production process that should result from implementing the optimal updated production plan; calculating a breakeven value for a raw material transaction using a difference between the estimated reference profit and the estimated updated profit; and outputting for display the breakeven value for the raw material transaction.

Embodiment 2. The method of embodiment 1, wherein the raw material transaction is selling a designated amount of a specific raw material that has already been purchased and the breakeven value is a breakeven selling price.

Embodiment 3. The method of embodiment 2, wherein the first set of inputs include the designated amount of the specific raw material and the second set of inputs does not include the designated amount of the specific raw material.

Embodiment 4. The method as in any one of embodiments 1, 2, and 3, wherein said calculating the breakeven selling price for the designated amount comprises adding a proposed income from selling the designated amount of the specific raw material to the difference between the estimated reference profit and the estimated updated profit.

Embodiment 5. The method as in any one of embodiments 1, 2, 3, and 4, wherein the raw material transaction is purchasing a designated amount of a specific raw material that is not included in the optimal reference production plan and the breakeven value is a breakeven purchase price.

Embodiment 6. The method as in any one of embodiments 1, 2, 3, 4 and 5, wherein said calculating the breakeven purchase price for the designated amount comprises including the designated amount of the specific raw material in the second set of inputs with a hypothetical purchase price of $0.

Embodiment 7. The method as in any one of embodiments 1, 2, 3, 4, 5 and 6, wherein the computer model is a multi-period optimization model that simultaneously optimizes both a volume of raw materials purchased and delivery timing of the volume of raw materials within a sub-period of a planning horizon.

Embodiment 8. A method for modeling raw material valuation, comprising: receiving an indication that a production disruption in a chemical production process will occur within a planning horizon; receiving a first set of inputs for the chemical production process, the first set of inputs comprising existing raw material information; calculating an optimal reference production plan for the chemical production process using the first set of inputs, wherein the optimal reference production plan is calculated using a computer model of the chemical production process that incorporates the production disruption; calculating an estimated reference profit for the chemical production process that will result from implementing the optimal reference production plan; receiving a second set of inputs for the chemical production process, wherein the second set of inputs does not comprise an amount of a designated raw material that is included in the first set of inputs; calculating an optimal updated production plan for the chemical production process using the second set of inputs, wherein the optimal updated production plan is calculated using the computer model of the chemical production process that incorporates the production disruption; calculating an estimated updated profit for the chemical production process that should result from implementing the optimal updated production plan; calculating a breakeven selling price for the amount of the designated raw material using a difference between the estimated reference profit and the estimated updated profit; and outputting for display the breakeven selling price for the amount of the designated raw material.

Embodiment 9. The method of embodiment 8, wherein the amount of the designated raw material is in inventory.

Embodiment 10. The method as in any one of embodiments 8 and 9, wherein the amount of the designated raw material is in not in inventory, but is scheduled for delivery.

Embodiment 11. The method of embodiment 10, wherein the computer model is a multi-period optimization model that simultaneously optimizes both a volume of raw materials purchased and delivery timing of the volume of raw materials within a sub-period of a planning horizon.

Embodiment 12. The method of embodiment 11, wherein the sub-period is one day.

Embodiment 13. The method as in any one of embodiments 8, 9, 10, 11, and 12, wherein said calculating the breakeven selling price for the amount of the designated raw material comprises adding a proposed income for selling the amount of the designated raw material to the difference between the estimated reference profit and the estimated updated profit.

Embodiment 14. The method as in any one of embodiments 8, 9, 10, 11, 12 and 13, wherein the chemical production process is an oil refinery process.

Embodiment 15. A method for modeling raw material valuation, comprising: receiving a first set of inputs for a chemical production process, the first set of inputs comprising existing raw material information; calculating an optimal reference production plan for the chemical production process using the first set of inputs, wherein the optimal reference production plan is calculated using a computer model of the chemical production process; calculating an estimated reference profit for the chemical production process that will result from implementing the optimal reference production plan; receiving a second set of inputs for the chemical production process, wherein the second set of inputs differ from the first set of inputs; calculating an optimal updated production plan for the chemical production process using the second set of inputs, wherein the optimal updated production plan is calculated using the computer model of the chemical production process; calculating an estimated updated profit for the chemical production process that should result from implementing the optimal updated production plan; calculating a breakeven purchase price for a proposed raw material purchase of a designated amount of a raw material using a difference between the estimated reference profit and the estimated updated profit; and outputting for display the breakeven purchase price for the designated amount.

Embodiment 16. The method of embodiment 15, wherein the first set of inputs comprise price information for raw materials and one or more products produced by the chemical production process.

Embodiment 17. The method as in any one of embodiments 15 and 16, wherein said calculating the breakeven purchase price for the designated amount comprises including the designated amount of the raw material in the second set of inputs with a hypothetical purchase price of $0.

Embodiment 18. The method as in any one of embodiments 15, 16, and 17, wherein the computer model is a multi-period optimization model that simultaneously optimizes both a volume of raw materials purchased and delivery timing of the volume of raw materials within a sub-period of a planning period.

Embodiment 19. The method of embodiment 18, wherein the sub-period is one day.

Embodiment 20. The method as in any one of embodiments 15, 16, 17, 18 and 19, wherein the chemical production process is an oil refinery process.

The present invention has been described above with reference to numerous embodiments and specific examples. Many variations will suggest themselves to those skilled in this art in light of the above detailed description. All such obvious variations are within the full intended scope of the appended claims.

1. A method for modeling raw material valuation, comprising:
receiving a first set of inputs for a chemical production process, the first set of inputs comprising existing raw material information;
calculating an optimal reference production plan for the chemical production process using the first set of inputs, wherein the optimal reference production plan is calculated using a computer model of the chemical production process;
calculating an estimated reference profit for the chemical production process that will result from implementing the optimal reference production plan;
receiving a second set of inputs for the chemical production process, wherein the second set of inputs differs from the first set of inputs;
calculating an optimal updated production plan for the chemical production process using the second set of inputs, wherein the optimal updated production plan is calculated using the computer model of the chemical production process;
calculating an estimated updated profit for the chemical production process that should result from implementing the optimal updated production plan;
calculating a breakeven value for a raw material transaction using a difference between the estimated reference profit and the estimated updated profit; and
outputting for display the breakeven value for the raw material transaction.

2. The method of claim 1, wherein the raw material transaction is selling a designated amount of a specific raw material that has already been purchased and the breakeven value is a breakeven selling price.

3. The method of claim 2, wherein the first set of inputs include the designated amount of the specific raw material and the second set of inputs does not include the designated amount of the specific raw material.

4. The method of claim 2, wherein said calculating the breakeven selling price for the designated amount comprises adding a proposed income from selling the designated amount of the specific raw material to the difference between the estimated reference profit and the estimated updated profit.

5. The method of claim 1, wherein the raw material transaction is purchasing a designated amount of a specific raw material that is not included in the optimal reference production plan and the breakeven value is a breakeven purchase price.

6. The method of claim 5, wherein said calculating the breakeven purchase price for the designated amount comprises including the designated amount of the specific raw material in the second set of inputs with a hypothetical purchase price of $0.

7. The method of claim 1, wherein the computer model is a multi-period optimization model that simultaneously optimizes both a volume of raw materials purchased and delivery timing of the volume of raw materials within a sub-period of a planning horizon.

8. A method for modeling raw material valuation, comprising:
receiving an indication that a production disruption in a chemical production process will occur within a planning horizon;
receiving a first set of inputs for the chemical production process, the first set of inputs comprising existing raw material information;
calculating an optimal reference production plan for the chemical production process using the first set of inputs, wherein the optimal reference production plan is calculated using a computer model of the chemical production process that incorporates the production disruption;
calculating an estimated reference profit for the chemical production process that will result from implementing the optimal reference production plan;
receiving a second set of inputs for the chemical production process, wherein the second set of inputs does not comprise an amount of a designated raw material that is included in the first set of inputs;
calculating an optimal updated production plan for the chemical production process using the second set of inputs, wherein the optimal updated production plan is calculated using the computer model of the chemical production process that incorporates the production disruption;
calculating an estimated updated profit for the chemical production process that should result from implementing the optimal updated production plan;
calculating a breakeven selling price for the amount of the designated raw material using a difference between the estimated reference profit and the estimated updated profit; and
outputting for display the breakeven selling price for the amount of the designated raw material.

9. The method of claim 8, wherein the amount of the designated raw material is in inventory.

10. The method of claim 8, wherein the amount of the designated raw material is in not in inventory, but is scheduled for delivery.

11. The method of claim 10, wherein the computer model is a multi-period optimization model that simultaneously optimizes both a volume of raw materials purchased and delivery timing of the volume of raw materials within a sub-period of a planning horizon.

12. The method of claim 11, wherein the sub-period is one day.

13. The method of claim 8, wherein said calculating the breakeven selling price for the amount of the designated raw material comprises adding a proposed income for selling the amount of the designated raw material to the difference between the estimated reference profit and the estimated updated profit.

14. The method of claim 8, wherein the chemical production process is an oil refinery process.

15. A method for modeling raw material valuation, comprising:
receiving a first set of inputs for a chemical production process, the first set of inputs comprising existing raw material information;
calculating an optimal reference production plan for the chemical production process using the first set of inputs, wherein the optimal reference production plan is calculated using a computer model of the chemical production process;
calculating an estimated reference profit for the chemical production process that will result from implementing the optimal reference production plan;
receiving a second set of inputs for the chemical production process, wherein the second set of inputs differ from the first set of inputs;
calculating an optimal updated production plan for the chemical production process using the second set of inputs, wherein the optimal updated production plan is calculated using the computer model of the chemical production process;
calculating an estimated updated profit for the chemical production process that should result from implementing the optimal updated production plan;
calculating a breakeven purchase price for a proposed raw material purchase of a designated amount of a raw material using a difference between the estimated reference profit and the estimated updated profit; and
outputting for display the breakeven purchase price for the designated amount.

16. The method of claim 15, wherein the first set of inputs comprise price information for raw materials and one or more products produced by the chemical production process.

17. The method of claim 15, wherein said calculating the breakeven purchase price for the designated amount comprises including the designated amount of the raw material in the second set of inputs with a hypothetical purchase price of $0.

18. The method of claim 15, wherein the computer model is a multi-period optimization model that simultaneously optimizes both a volume of raw materials purchased and delivery timing of the volume of raw materials within a sub-period of a planning period.

19. The method of claim 18, wherein the sub-period is one day.

20. The method of claim 15, wherein the chemical production process is an oil refinery process.
